(19) United States
(12) Patent Application Publication
(10) Pub. No.: US 2003/0023681 A1
(43) Pub. Date: Jan. 30, 2003

(54) Sharing messaging device information among network users

(75) Inventors: Michael Wayne Brown, Georgetown, TX (US); Rabindranath Dutta, Austin, TX (US); Michael A. Paolini, Austin, TX (US)

Correspondence Address: International Business Machines Corporation, Intellectual Property Law Department, Internal Zip 4054, 11400 Burnet Road, Austin, TX, 78758, US

(73) Assignee: International Business Machines Corporation, Armonk, NY

(21) Appl. No.: 09/915,458

(22) Filed: Jul. 26, 2001

(51) Int. Cl. G06F 15/16

(52) U.S. Cl. 709/204; 709/224

(57) ABSTRACT

A method, system and program for sharing message device information among multiple devices participating in network communications in an electronic system are provided. Device information for each device utilized by a user to participate in a messaging system is determined and transmitted to a messaging server. The device information is then filtered according to authorization preferences. Next, the filtered device information is distributed to the devices for multiple users participating in the messaging session, such that each of the multiple users is enabled to monitor each other device utilized by the other particular users during the messaging session.

### CROSS-REFERENCE TO RELATED APPLICATIONS

The present application is related to the following copending applications, which are filed on even date herewith and incorporated herein by reference:

(1) U.S. patent application Ser. No. __/____ (Attorney Docket No. AUS920010391US1);

(2) U.S. patent application Ser. No. __/____ (Attorney Docket No. AUS920010392US1);

(3) U.S. patent application Ser. No. __/____ (Attorney Docket No. AUS920010393US1);

(4) U.S. patent application Ser. No. __/____ (Attorney Docket No. AUS920010396US1);

(5) U.S. patent application Ser. No. __/____ (Attorney Docket No. AUS920010397US1);

(6) U.S. patent application Ser. No. __/____ (Attorney Docket No. AUS920010528US1); and

(7) U.S. patent application Ser. No. __/____ (Attorney Docket No. AUS920010553US1).

### BACKGROUND OF THE INVENTION

1. Technical Field

The present invention relates in general to electronic communications and, in particular, to sharing message device information among multiple devices participating in network communications. Still more particularly, the present invention relates to monitoring device information for devices utilized in a messaging session and controlling distribution of the device information such that each network user is enabled to monitor the status of devices utilized in a messaging session.

2. Description of the Related Art

As the Internet and telephony expand, the ease of communications between individuals in different locations continues to expand as well. One type of electronic communication is supported by messaging which includes the use of computer systems and data communication equipment to convey messages from one person to another, as by e-mail, voice mail, unified messaging, instant messaging, or fax.

Messaging systems in particular allow multiple users to participate in a messaging session where each user is utilizing one of multiple diverse available platforms and where some users may be participating utilizing wireless communications and others utilizing wired communications. For example, one user may be participating in the messaging session via a portable communication device such as a digital telephone or personal digital assistant. In addition, another user participating in the messaging session may utilize a workstation.

Adding portable communication devices to messaging sessions further enhances communications between users in multiple remote areas. However, while portable communication devices do provide enhanced communication from remote areas, portable communication devices are typically limited in other ways including, but not limited to, power availability, strength of signal and cost for service.

While the user of a portable communication device may be provided with information for that device from monitoring power available, strength of signal, cost for service and location, portable communication devices are limited in that there is not controlled sharing of this information between users participating in a messaging session. Such a limitation becomes prevalent where a user drops out of a messaging session because a signal level is low or the power on the user's device has dropped, but the other users in the messaging session are not provided with information that would indicate why the user has dropped from the session.

In another example, limitations in portable communication devices are prevalent in business contexts where some users are utilizing portable communication devices to participate in a messaging session, but the cost of that session is not provided to other users. Where one of those other users was a client, the client might decide, based on the costs associated with utilizing a certain portable communication device, to reconvene the messaging session at a later time or utilize alternate messaging devices.

In view of the foregoing, it would be advantageous to provide a method, system and program for sharing current information about each device being utilized in a messaging session among the participants in that messaging session. In particular, it would be advantageous to allow a user to control what information about the functioning of that user's device is shared among participants in a messaging session.

### SUMMARY OF THE INVENTION

In view of the foregoing, it is therefore an object of the present invention to provide an improved method, system and program for performing electronic communications.

It is another object of the present invention to provide a method, system and program for sharing message device information among multiple devices participating in network communications.

It is yet another object of the present invention to provide a method, system and program for monitoring device information for devices utilized in a messaging session and controlling distribution of the device information such that each network user is enabled to monitor the status of devices utilized in a messaging session.

According to one aspect of the present invention, device information for a particular device utilized by a particular user participating in a messaging session is received. The device information is then filtered according to authorization preferences. Next, the filtered device information is distributed to multiple users participating in the messaging session, such that each of the multiple users is enabled to monitor the particular device utilized by the particular user during the messaging session.

According to another aspect of the present invention, device information for multiple devices utilized by multiple users participating in a messaging session is received at a particular device from among the multiple devices. The device information is then output through the particular device according to device output preferences, such that the particular device monitors the device information for the multiple devices utilized in the messaging session. In addition, the device information for that particular device is determined and transmitted for distribution to the other devices utilized in the messaging session.

All objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 depicts one embodiment of a computer system with which the method, system and program of the present invention may advantageously be utilized;

FIG. 2 illustrates a simplified block diagram of a client/server environment in which electronic messaging typically takes place in accordance with the method, system and program of the present invention;

FIG. 3 depicts a block diagram of one embodiment of a messaging server in accordance with the method, system and program of the present invention;

FIG. 4 illustrates a graphical representation of a messaging session window in accordance with the method, system and program of the present invention;

FIG. 5 depicts a graphical representation of a messaging session interface for a compact portable communication device in accordance with the method, system and program of the present invention;

FIG. 6 illustrates a graphical representation of a device information preferences window in accordance with the method, system and program of the present invention;

FIG. 7 depicts a high level logic flowchart of a process and program for controlling distribution of device information among users participating in a messaging session in accordance with the method, system and program of the present invention; and

FIG. 8 illustrates a high level logic flowchart of a process and program for controlling output of device information at a user device in accordance with the method, system and program of the present invention.

### DETAILED DESCRIPTION OF THE PREFERRED EMBODIMENT

A method, system and program for sharing electronic device information among multiple users in a messaging session are provided. In the present invention “electronic device” may include, but is not limited to, wired and wireless, portable and non-portable computing systems as will be further described. The “electronic device information” may include, but is not limited to, type of device, power level, signal strength, cost of session per user, number of entries received per user, location, loss of packets, bandwidth availability, and other information that aids users participating in a messaging session. Further, the electronic device information may include, but is not limited to, pre-set information such as spending limits, current information and post messaging session information, such as the total number minutes for the messaging session.

A “messaging session” preferably includes, but is not limited to, any combination of voice, graphical, video, and/or text messages, instant and/or delayed, transmitted between multiple users via a network. Messaging sessions may include use of chat rooms, instant messages, e-mail, conference calling and other network methods of providing a channel for users to communicate within. Further, messaging sessions may include communications such as voice and text transmissions between multiple telephony devices.

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

### Hardware Overview

The present invention may be executed in a variety of systems, including a variety of computing systems and electronic devices under a number of different operating systems. In one embodiment of the present invention, the messaging system is a portable computing system such as a notebook computer, a palmtop computer, a personal digital assistant, a telephone or other electronic computing system that may also incorporate communications features that provide for telephony, enhanced telephony, messaging and information services. However, the messaging system may also be, for example, a desktop computer, a network computer, a midrange computer, a server system or a mainframe computer. Therefore, in general, the present invention is preferably executed in a computer system that performs computing tasks such as manipulating data in storage that is accessible to the computer system. In addition, the computer system preferably includes at least one output device and at least one input device.

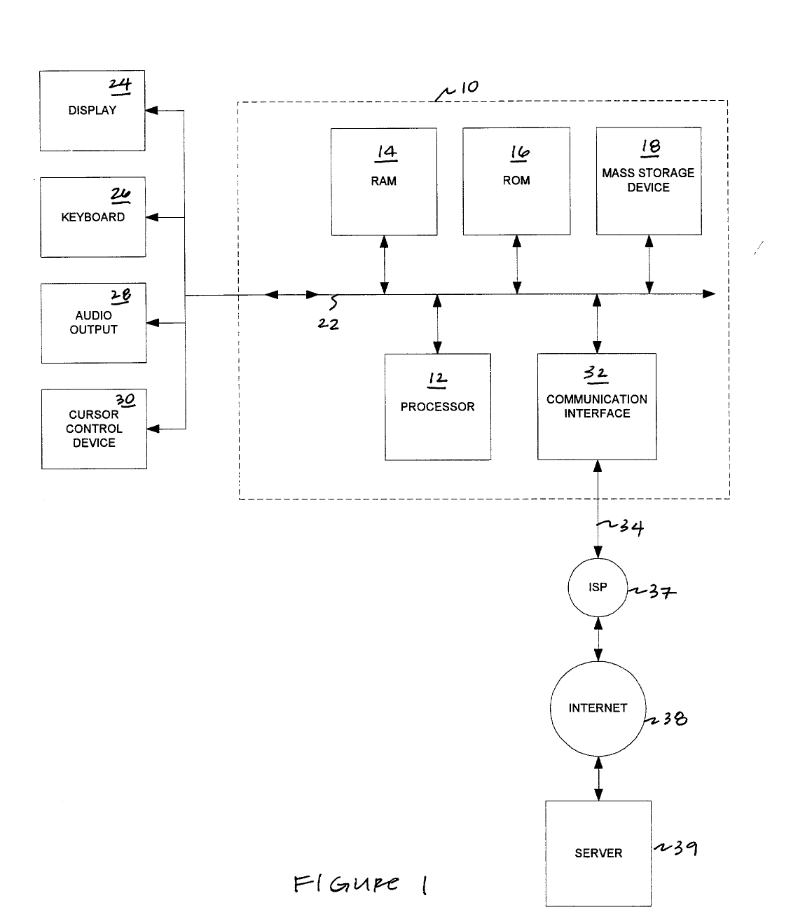

Referring now to the drawings and in particular to FIG. 1, there is depicted one embodiment of a computer system with which the method, system and program of the present invention may advantageously be utilized. Computer system 10 comprises a bus 22 or other communication device for communicating information within computer system 10, and at least one processing device such as processor 12, coupled to bus 22 for processing information. Bus 22 preferably includes low-latency and high-latency paths that are connected by bridges and controlled within computer system 10 by multiple bus controllers.

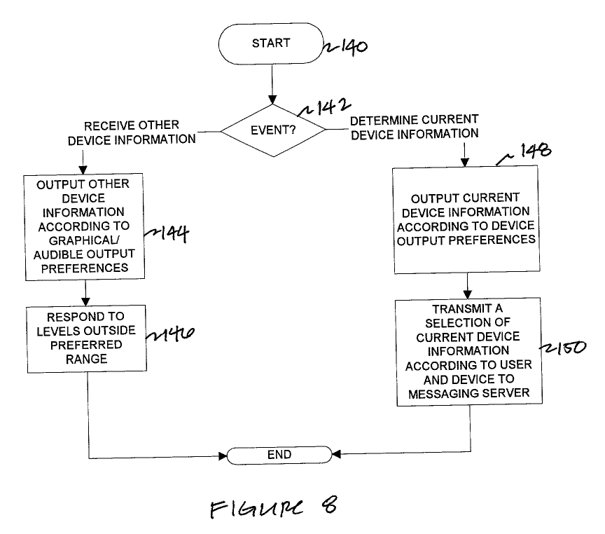

Processor 12 may be a general-purpose processor such as IBM's PowerPC™ processor that, during normal operation, processes data under the control of operating system and application software stored in a dynamic storage device such as random access memory (RAM) 14 and a static storage device such as Read Only Memory (ROM) 16. The operating system preferably provides a graphical user interface (GUI) to the user. In a preferred embodiment, application software contains machine executable instructions that when executed on processor 12 carry out the operations depicted in the flowcharts of FIGS. 7, 8, and others described herein. Alternatively, the steps of the present invention might be performed by specific hardware components that contain hardwire logic for performing the steps, or by any combination of programmed computer components and custom hardware components.

The present invention may be provided as a computer program product, included on a machine-readable medium having stored thereon the machine executable instructions used to program computer system 10 to perform a process according to the present invention. The term “machine-readable medium” as used herein includes any medium that participates in providing instructions to processor 12 or other components of computer system 10 for execution. Such a medium may take many forms including, but not limited to, non-volatile media, volatile media, and transmission media. Common forms of non-volatile media include, for example, a floppy disk, a flexible disk, a hard disk, magnetic tape or any other magnetic medium, a compact disc ROM (CD-ROM), a digital video disc-ROM (DVD-ROM) or any other optical medium, punch cards or any other physical medium with patters of holes, a programmable ROM (PROM), an erasable PROM (EPROM), electrically EPROM (EEPROM), a flash memory, any other memory chip or cartridge, or any other medium from which computer system 10 can read and which is suitable for storing instructions. In the present embodiment, an example of non-volatile media is storage device 18. Volatile media includes dynamic memory such as RAM 14. Transmission media includes coaxial cables, copper wire or fiber optics, including the wires that comprise bus 22. Transmission media can also take the form of acoustic or light waves, such as those generated during radio wave or infrared data communications.

Moreover, the present invention may be downloaded as a computer program product, wherein the program instructions may be transferred from a remote computer such as a server 39 to requesting computer system 10 by way of data signals embodied in a carrier wave or other propagation medium via a network link 34 (e.g., a modem or network connection) to a communications interface 32 coupled to bus 22. Communications interface 32 provides a two-way data communications coupling to network link 34 that may be connected, for example, to a local area network (LAN), wide area network (WAN), or as depicted herein, directly to an Internet Service Provider (ISP) 37. In particular, network link 34 may provide wired and/or wireless network communications to one or more networks.

ISP 37 in turn provides data communication services through the Internet 38 or other network. Internet 38 may refer to the worldwide collection of networks and gateways that use a particular protocol, such as Transmission Control Protocol (TCP) and Internet Protocol (IP), to communicate with one another. ISP 37 and Internet 38 both use electrical, electromagnetic, or optical signals that carry digital data streams. The signals through the various networks and the signals on network link 34 and through communication interface 32, which carry the digital data to and from computer system 10, are exemplary forms of carrier waves transporting the information.

Further, multiple peripheral components may be added to computer system 10. For example, an audio output 28 is attached to bus 22 for controlling audio output through a speaker or other audio projection device. A display 24 is also attached to bus 22 for providing visual, tactile or other graphical representation formats. A keyboard 26 and cursor control device 30, such as a mouse, trackball, or cursor direction keys, are coupled to bus 22 as interfaces for user inputs to computer system 10. In alternate embodiments of the present invention, additional input and output peripheral components may be added.

### Messaging Systems Context

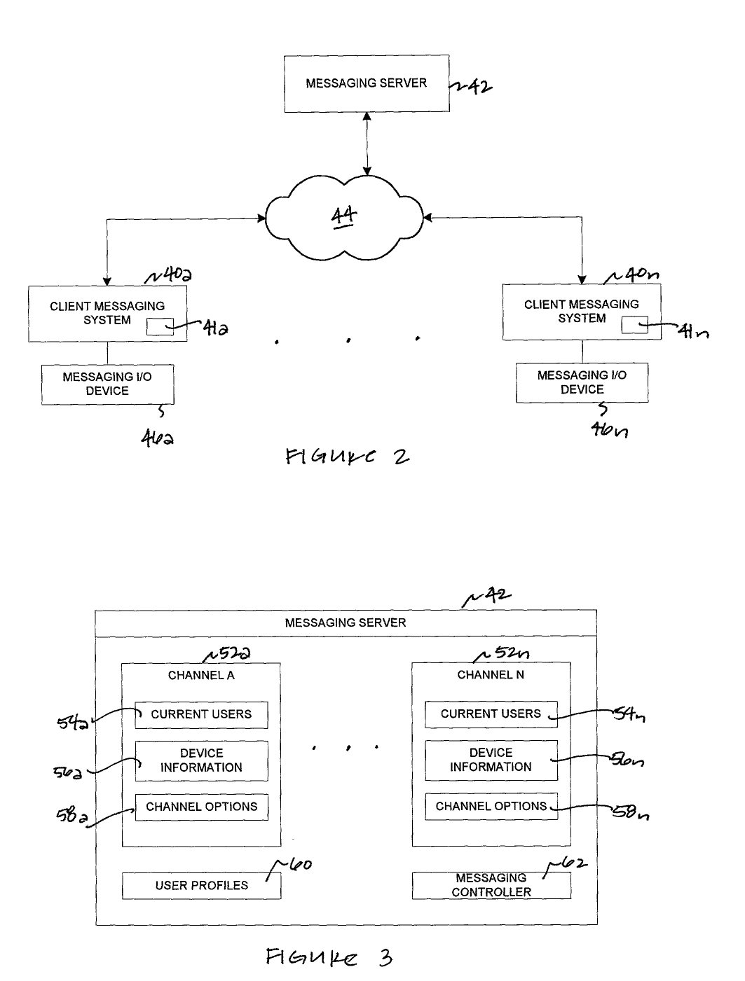

With reference now to FIG. 2, there is depicted a simplified block diagram of a client/server environment in which electronic messaging typically takes place in accordance with the method, system and program of the present invention. The client/server environment is implemented within multiple network architectures. For example, the architecture of the World Wide Web (the Web) follows a traditional client/server modeled environment.

The terms “client” and “server” are used to refer to a computer's general role as a requester of data (the client) or provider of data (the server). In the Web environment, web browsers such as Netscape Navigator typically reside on client messaging systems 40a-40n and render Web documents (pages) served by at least one messaging server such as messaging server 42. Additionally, each of client messaging systems 40a-40n and messaging server 42 may function as both a “client” and a “server” and may be implemented utilizing a computer system such as computer system 10 of FIG. 1.

Further, while the present invention is described with emphasis upon messaging server 42 controlling a messaging session, the present invention may also be performed by client messaging systems 40a-40n engaged in peer-to-peer network communications via a network 44.

The Web may refer to the total set of interlinked hypertext documents residing on servers all around the world. A network 44, such as the Internet, provides an infrastructure for transmitting these hypertext documents between client messaging systems 40a-40n and messaging server 42. Documents (pages) on the Web may be written in multiple languages, such as Hypertext Markup Language (HTML) or Extensible Markup Language (XML), and identified by Uniform Resource Indicators (URIs) that specify the particular messaging server 42 and pathname by which a file can be accessed, and then transmitted from messaging server 42 to an end user utilizing a protocol such as Hypertext Transfer Protocol (HTTP). Web pages may further include text, graphic images, movie files, and sounds as well as Java applets and other small embedded software programs that execute when the user activates them by clicking on a link.

Advantageously, in the present invention, a client enters a message via one of messaging input/output (I/O) devices 46a-46n for a messaging session at a client messaging system such as client messaging system 40a. The message entry is transmitted to messaging server 42. Messaging server 42 then distributes the message to the participating users via network 44.

In addition, in the present invention, information about each of client messaging systems 40a-40n is determined at the device or by another system monitoring the device and that device information is transmitted to messaging server 42. Messaging server 42 then filters the device information according to the user preferences for each device and distributes the filtered device information to each of client messaging systems 40a-40n. In addition, messaging server 42 may downgrade message entry transmissions for each device based on the device capabilities. For example, if the bandwidth or signal strength of a device is detected to be below a particular range, graphics included in a message entry may be eliminated for that device.

In an alternate embodiment, device information may be accessible to client messaging systems 40a-40n as files, in a directory, that is accessible to users associated with the messaging session. In addition, the device information may be transmitted as e-mail to participants in the messaging session, where the e-mail application functioning on the client messaging system automatically determines that the e-mail contains device information and outputs the device information according to user preferences. Moreover, the present invention may utilize a traditional IRC channel for transmitting message entries and a special IRC device channel opened in parallel with the traditional IRC channel for transmitting the device information among users. Furthermore, other types of messaging systems may be utilized to implement the present invention, as will be understood by one skilled in the art.

Device information received at each of client messaging systems 40a-40n is output via messaging I/O devices 46a-46n according to user graphical and audio preferences. Advantageously, the steps of monitoring, transmitting and outputting device information are performed by an application executing in each of client messaging systems 40a-40n, such as monitoring applications 41a-41n.

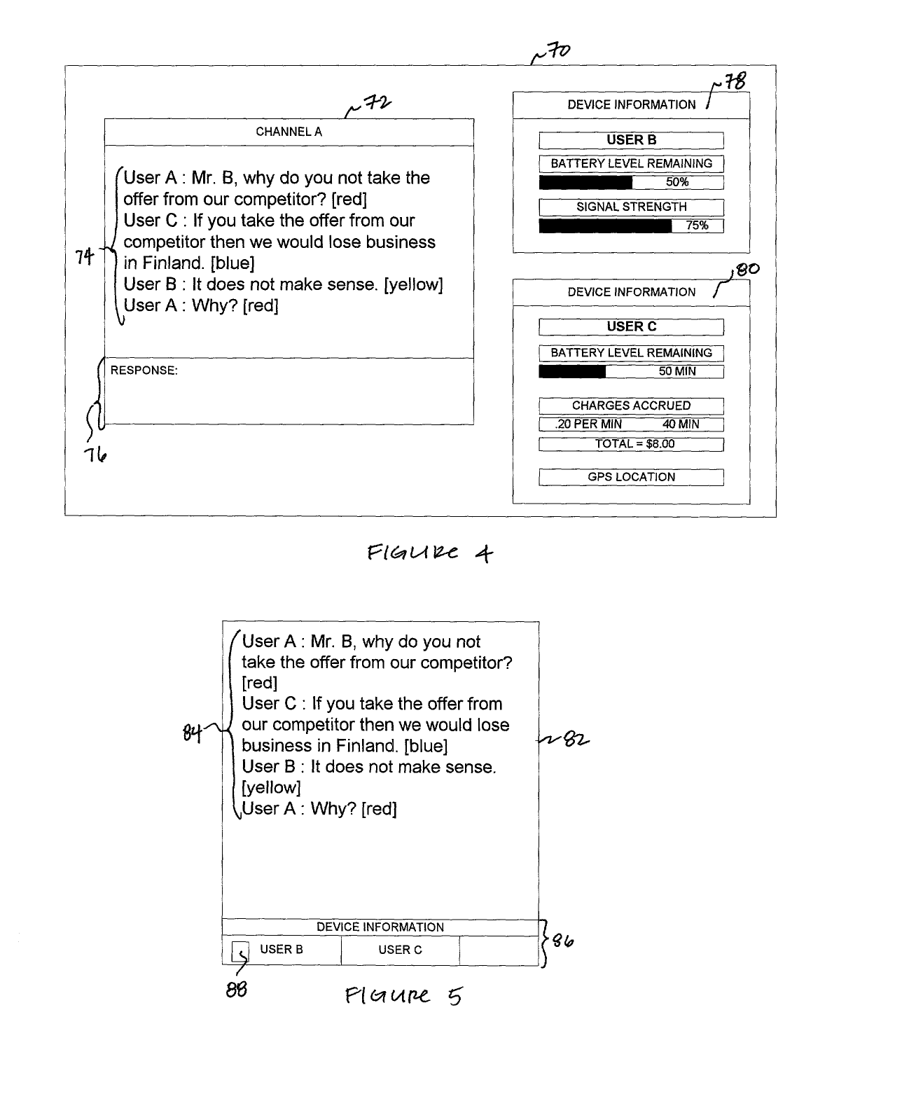

Referring now to FIG. 3, there is illustrated a block diagram of one embodiment of a messaging server in accordance with the method, system and program of the present invention. As depicted, messaging server 42 includes a messaging controller 62 that is provided to control the process steps of messaging server 42 as will be further described.

Messaging server 42 also includes multiple channels 52a-52n. Each of channels 52a-52n may represent a separate information path within messaging server 42 in which multiple users may participate in a messaging session. Messaging server 42 may have a defined number of channels 52a-52n or may allow users to create new channels as needed. In particular, channels provide network paths between multiple users for both voice, graphical, and text communications. Each of channels 52a-52n may further include multiple distinguishable topics.

In addition, each of channels 52a-52n preferably includes a table of current users 54a-54n. As a user selects to participate in channels 52a-52n, the user's identification is added to the table of current users 54a-54n for that channel. In particular, the table of current users 54a-54n may further specify participation in a selection of topics from among the topics available in a selected channel.

Preferably, as messaging server 42 receives messages, they may be stored according to the channel, topic and user and then distributed to each of the users participating in that channel. Where both voice and text are being utilized in a single messaging session, messaging server 42 may transmit both voice and text or messaging server 42 may translate all entries into either voice or text before distributing entries to the users participating in the channel.

Channels 52a-52n further respectively include device information databases 56a-56n. Each of device information databases 56a-56n includes device information for each user planning to participate, currently participating, or has participated in the channel. Preferably such device information includes a power level, signal strength, cost, type of device, location and other device related information.

Device information is distributed to current users based on device output preferences, as will be further described, for each user and channel options 58a-58n for each of channels 52a-52n, respectively. Device output preferences indicate which types of device information a user authorizes to be distributed to a selection of users. Channel options 58a-58n indicate which types of device information are authorized to be distributed to the current participants in the channel. For example, the channel options for a first channel may limit distribution of device information to only power level information while the channel options for a second channel may expand distribution to all available device information. Channel options 58a-58n may be pre-designated such that users may select a channel based on the level of authorization. Alternatively, channel options 58a-58n may be set by a user or a group of users.

In the present invention, channel options 58a-58n are particularly advantageous where a user may select to participate in a channel where the bandwidth of information is regulated according to the channel option. Therefore, if a user selects a channel where the channel option is set to a low bandwidth threshold, then data contained in message entries will be filtered to meet the limited bandwidth. Alternatively, a channel with a channel option set to a high bandwidth threshold may be selected where speed and large amounts of data are expected.

Messaging server 42 includes a user profiles database 60 that includes profile information for each user including, but not limited to, a user identification, a name, an e-mail address, device output preferences and a user history recorded as the user participates in messaging sessions. The user identification stored in user profiles 60 during registration is utilized across multiple channels for identifying entries provided by that user. Device output preferences, as will be further described, may be stored with user profiles database 60 and/or at each client messaging system.

A messaging controller 62 is advantageously a software application executing within messaging server 42 in order to allow users to designate device output preferences such that device information received for the user's device is distributed according to preferences.

With reference now to FIG. 4, there is depicted a graphical representation of a messaging session interface in accordance with the method, system and program of the present invention. As depicted, messaging session window 70 includes a message entry display 72 and device information displays 78 and 80.

Message entry display 72 depicts multiple message entries 74 communicated in channel A. In the example illustrated, message entries 74 includes entries from users A, B and C, each graphically distinguished by a color as indicated within brackets. In addition, message entry display 72 illustrates a response entry 76 where a user may enter a message for communication within a channel.

Device information display 78 illustrates device information for user B while device information display 80 depicts device information for user C. In the example, device information for user B includes the battery level remaining and signal strength. Advantageously, when the battery level of another device is available, a user may determine how long the user of the other device may participate in a messaging session. Morever, advantageously, when the signal strength of another device is available, a user may determine what types of transmissions will be received by the other user, the speed of communications and other factors that may be determined from the signal strength.

In addition, in the example, device information for user C includes the battery level remaining, charges accrued and global positioning system (GPS) location. Particularly advantageous, where a user is being billed for the charges accrued during a messaging session, that user may monitor the charges accrued by other devices participating in the messaging session whether the user is participating in that messaging session or not. In addition, where the charges accrued on another device are provided and a pre-set spending limit has been designated, a user may monitor the amount of time remaining for the other device.

Preferably, each user may designate in device output preferences how device information will be graphically or audibly output at that user's device. In particular, a user may select to graphically display device information by user in separate windows, as illustrated in the present example. In addition, if provided, a user may select among multiple units to output information. In the example depicted, a battery level remaining is output by the units of percent remaining and time remaining.

In addition, although not depicted, a user may select to graphically aggregate device information. For example, the battery level remaining and signal strength may be aggregated into a signal value indicating the likelihood of the device dropping out of the messaging session.

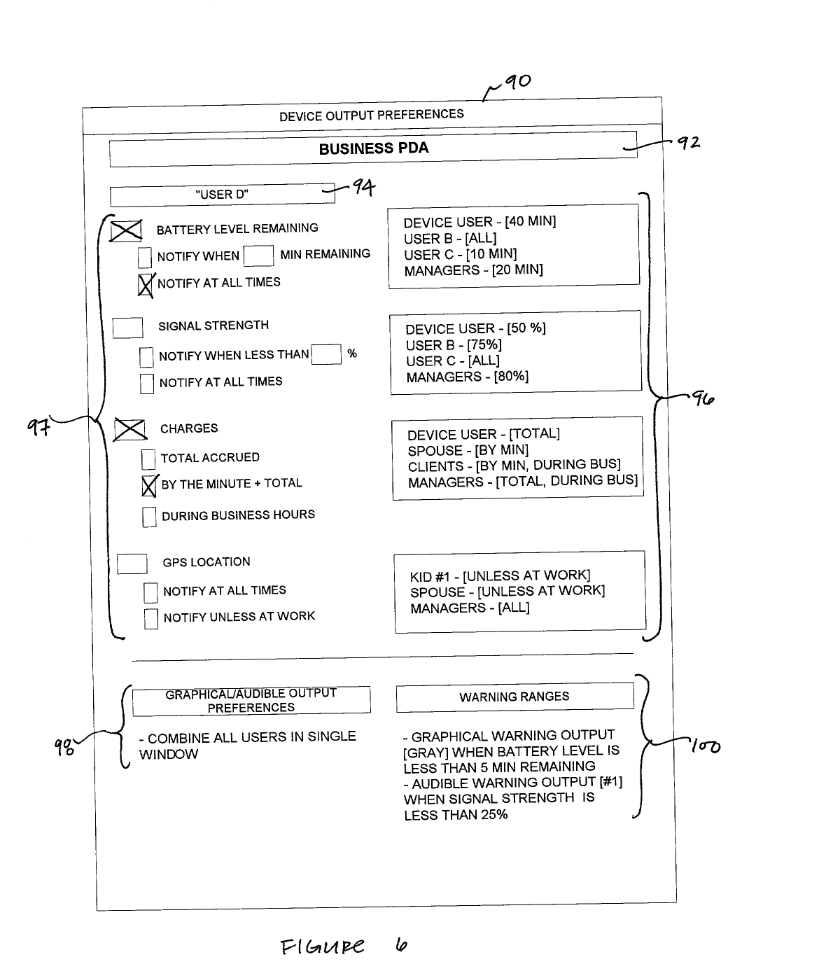

Referring now to FIG. 5, there is illustrated a graphical representation of a messaging session interface for a compact portable communication device in accordance with the method, system and program of the present invention. As depicted, a device interface 82 includes multiple message entries 84 from multiple users.

Further, device interface 82 includes selectable device information for multiple users as depicted at reference numeral 86. For example, a user may select user A and device interface 82 will display device information for user A. In addition, device interface 82 may include icons or other graphical representations such as battery icon 88 that indicate, for example, when user A's battery levels are outside of the current user's preferred range.

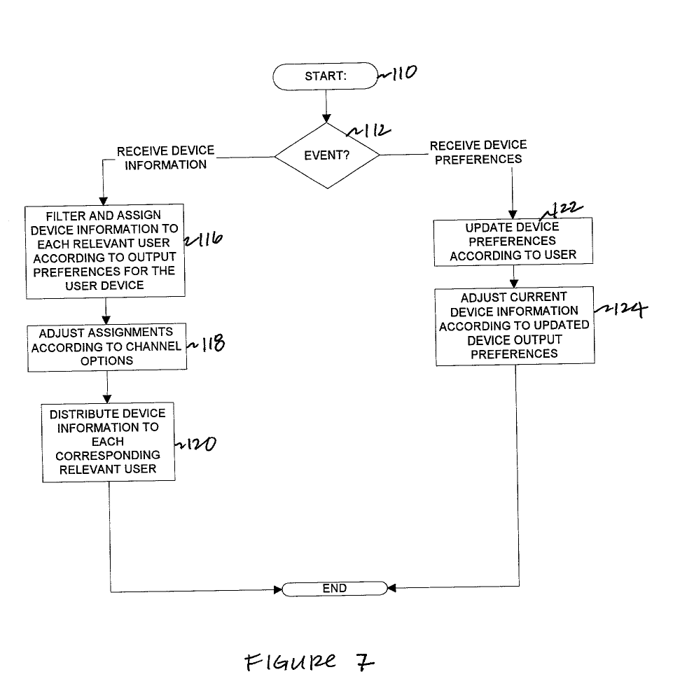

With reference now to FIG. 6, there is illustrated a graphical representation of a device output preferences window in accordance with the method, system and program of the present invention. As illustrated, a device output preferences window 90 may include, but is not limited to, a device indicator 92, a user identification 94, device output selections 96, device output options 97, an output preferences selection 98, and a range selection 100.

Device indicator 92 indicates which device the current device output preferences reference. While in the present example the device indicator is set to a business personal digital assistant (PDA), preferably, a user can designate preferences for multiple devices that are referenced in device indicator 92 by a name. In referencing devices, preferably a user provides information about the device specifications such that the device specifications for the device being utilized may be transmitted with device information.

User identification 94 indicates a user identification for which output of device information is being set by device output options 97. Preferably, a user can set output preferences for new users and adjust output preferences for current or past users.

Device output options 97 include multiple options for setting device information output authorization and currently selected output authorizations. In the present example, the options selected for user D are to notify user D at all times of the battery level remaining and to output the charges by the minute and total for the messaging session.

Device output selections 96 include multiple selections that have been made according to user. For example, the user of the device has designated to output the battery level on the device when less than forty minutes remain. The user has also designated to transmit the battery level of the home computer to user B's device at all times. However, the user has designated to transmit the battery level of the home computer to users tagged as “managers” only when twenty minutes remain. Advantageously, a user may control battery strength information according to the user receiving the information in order to control the amount of information that particular users have about the current user's device.

Specifying when a GPS location may be transmitted to other users as part of device information is particularly advantageous in order to make other users aware of where the user is currently located. In the present example, a user has selected to notify a user “kid #1” and a “spouse” of the GPS location of the business PDA unless at work. However, the user has selected to notify users tagged as “managers” of the GPS position of the business PDA at all times. Such a setting may be automatically placed in device output preferences by a business providing a PDA to an employee.

Output preferences selection 98 includes multiple output preferences selected by the current user. For example, the current user has selected to combine all users in a single window. Alternatively, the current user may select to separate users into individual windows. Moreover, the current user may select from options such as blocking particular types of device information from output.

Range selection 100 includes ranges within which the current user should be notified with a warning. The warning may be graphical, audible, or a combination thereof. In the present example, range selection 100 includes a graphical warning output of turning all graphical elements to gray when the battery level is less than 5 minutes remaining. Also, in the present example, range selection 100 includes an audible warning output “#1” when the signal strength is less than “25%”.

Referring now to FIG. 7, there is illustrated a high level logic flowchart of a process and program for controlling distribution of device information among users participating in a messaging session in accordance with the method, system and program of the present invention. As depicted, the process starts at block 110 and thereafter proceeds to block 112. Block 112 illustrates a determination as to which event occurred when an event occurs. If device information is received, then the process passes to block 116. If device output preferences are received, then the process passes to block 122.

Block 116 depicts filtering and assigning device information to each relevant user according to output preferences for the user device from which device information is received. Next, block 118 illustrates adjusting the assignments according to channel options. Thereafter, block 120 depicts distributing the device information to each corresponding relevant user and the process ends.

Block 122 illustrates updating device output preferences according to the user transmitting the preferences. Preferably, device output preferences are updated in the user profiles according to the user and device. Next, block 124 depicts adjusting current device information distributed to relevant users according to updated device output preferences and the process ends.

With reference now to FIG. 8, there is depicted a high level logic flowchart of a process and program for controlling output of device information at a user device in accordance with the method, system and program of the present invention. As illustrated, the process starts at block 140 and thereafter proceeds to block 142. Block 142 depicts a determination as to are what event occurred when an event occurs. If other device information for other devices is received, then the process passes to block 144. If current device information is determined, then the process passes to block 148.

Block 144 depicts outputting the other device information according to graphical and audible output preferences for the user device. Next, block 146 illustrates responding to levels outside the preferred range by providing warnings and the process ends.

Block 148 illustrates outputting the current device information according to device output preferences for the user device. Next, block 150 depicts transmitting a selection of current device information according to user and device to the messaging server and the process ends.

While the invention has been particularly shown and described with reference to a preferred embodiment, it will be understood by those skilled in the art that various changes in form and detail may be made therein without departing from the spirit and scope of the invention.

What is claimed is:

1. A method for controlling distribution of device information to a plurality of users participating in a messaging session, said method comprising the steps of:
receiving device information for a particular device utilized by a particular user participating in a messaging session;
filtering said device information according to authorization preferences; and
distributing said filtered device information to at least one other user participating in said messaging session, such that said at least one other user is enabled to monitor said particular device utilized by said particular user during said messaging session.

2. The method for controlling distribution of device information according to claim 1, said method further comprising the step of:
receiving said device information at, and distributing said filtered device information from, a messaging server communicatively connected via a network to said users.

3. The method for controlling distribution of device information according to claim 1, said method further comprising the step of:
receiving authorization preferences for said particular device from said particular user.

4. The method for controlling distribution of device information according to claim 1, said step of receiving device information for a particular device utilized by a particular user participating in a messaging system further comprising the step of:
receiving said device information comprising at least one from among a power level, a signal strength, a cost for participating, a device type, and a location.

5. The method for controlling distribution of device information according to claim 1, said step of filtering said device information according to authorization preferences, further comprising the step of:
filtering said device information according to user selected output preferences for said at least one other user.

6. The method for controlling distribution of device information according to claim 1, said step of filtering said device information according to authorization preferences, further comprising the step of:
filtering said device information according to authorization preferences selected for said messaging session.

7. The method for controlling distribution of device information according to claim 1, said step of filtering said device information according to authorization preferences, further comprising the step of:
filtering said device information according to a bandwidth associated with said messaging session.

8. A system for controlling distribution of device information to a plurality of users participating in a messaging session, said system comprising:
a server system communicatively connected to a network;
said server system further comprising:
means for receiving device information for a particular device utilized by a particular user participating in a messaging session;
means for filtering said device information according to authorization preferences; and
means for distributing said filtered device information to at least one other user participating in said messaging session, such that said at least one other user is enabled to monitor said particular device utilized by said particular user during said messaging session.

9. The system for controlling distribution of device information according to claim 8, wherein said server system is communicatively connected via a network to a plurality of devices utilized by a plurality of users.

10. The system for controlling distribution of device information according to claim 8, said server system further comprising:
means for receiving authorization preferences for said particular device from said particular user.

11. The system for controlling distribution of device information according to claim 8, said means for receiving device information for a particular device utilized by a particular user participating in a messaging system, further comprising:
means for receiving said device information comprising at least one from among a power level, a signal strength, a cost for participating, a device type, and a location.

12. The system for controlling distribution of device information according to claim 8, said means for filtering said device information according to authorization preferences, further comprising:
means for filtering said device information according to user selected output preferences for said at least one other user.

13. The system for controlling distribution of device information according to claim 8, said means for filtering said device information according to authorization preferences, further comprising:
means for filtering said device information according to authorization preferences selected for said messaging session.

14. The system for controlling distribution of device information according to claim 8, said means for filtering said device information according to authorization preferences, further comprising:
means for filtering said device information according to a bandwidth associated with said messaging session.

15. A program for controlling distribution of device information to a plurality of users participating in a messaging session, residing on a computer usable medium having computer readable program code means, said program comprising:
means for receiving device information for a particular device utilized by a particular user participating in a messaging session;
means for filtering said device information according to authorization preferences; and
means for distributing said filtered device information to at least one other user participating in said messaging session, such that said at least one other user is enabled to monitor said particular device utilized by said particular user during said messaging session.

16. The program for controlling distribution of device information according to claim 15, said program further comprising:
means for receiving authorization preferences for said particular device from said particular user.

17. The program for controlling distribution of device information according to claim 15, said program further comprising:
means for receiving said device information comprising at least one from among a power level, a signal strength, a cost for participating, a device type, and a location.

18. The program for controlling distribution of device information according to claim 15, said program further comprising:
means for filtering said device information according to user selected output preferences for said at least one other as user.

19. The program for controlling distribution of device information according to claim 15, said program further comprising:
means for filtering said device information according to authorization preferences selected for said messaging session.

20. The program for controlling distribution of device information according to claim 15, said program further comprising:
means for filtering said device information according to a bandwidth associated with said messaging session.

21. A method for participating in a messaging session, said method comprising the steps of:
determining device information for a particular device utilized by a particular user to participate in a messaging session; and
transmitting said current device information for distribution to at least one other user participating in said messaging session, such that said device information for said particular device is communicated within said messaging session.

22. The method for participating in a messaging session according to claim 21, said step of determining device information for a particular device further comprising the step of:
determining said device information comprising at least one from among a power level, a signal strength, a cost for participating, a device type, and a location.

23. The method for participating in a messaging session according to claim 21, said method further comprising the steps of:
filtering a selection of information from said device information according to user output preferences for said at least one other user; and
transmitting only said selection of information for distribution to said at least one other user.

24. A system for participating in a messaging session, said system comprising:
a client messaging system communicatively connected to a network;
said client messaging system further comprising:
means for determining device information for a particular device utilized by a particular user to participate in a messaging session; and
means for transmitting said current device information for distribution to at least one other user participating in said messaging session, such that said device information for said particular device is communicated within said messaging session.

25. The system for participating in a messaging session according to claim 24, said means for determining device information for a particular device further comprising:
means for determining said device information comprising at least one from among a power level, a signal strength, a cost for participating, a device type, and a location.

26. The system for participating in a messaging session according to claim 24, said client messaging system further comprising:
means for filtering a selection of information from said device information according to user output preferences for said at least one other user; and
means for transmitting only said selection of information for distribution to said at least one other user.

27. A program for participating in a messaging session, residing on a computer usable medium having computer readable program code means, said program comprising:
means for determining device information for a particular device utilized by a particular user to participate in a messaging session; and
means for transmitting said current device information for distribution to at least one other user participating in said messaging session, such that said device information for said particular device is communicated within said messaging session.

28. The program for participating in a messaging session according to claim 27, said program further comprising:
means for determining said device information comprising at least one from among a power level, a signal strength, a cost for participating, a device type, and a location.

29. The program for participating in a messaging session according to claim 27, said program further comprising:
means for filtering a selection of information from said device information according to user output preferences for said at least one other user; and
means for transmitting only said selection of information for distribution to said at least one other user.

30. A method for monitoring devices utilized within a messaging session, said method comprising the steps of:
receiving device information for at least one other device utilized by at least one other user participating in a messaging session at a particular device utilized by a particular user participating in said messaging session; and
outputting said device information through said particular device according to device output preferences, such that said particular device is enabled to monitor said device information for said at least one other device utilized in said messaging session.

31. The method for monitoring devices utilized within a messaging session according to claim 30, said step of receiving device information for at least one other device, further comprising the step of:
receiving said device information comprising at least one from among a power level, a signal strength, a cost for participating, a device type, and a location.

32. The method for monitoring devices utilized within a messaging session according to claim 30, said step of outputting said device information through said particular device according to device output preferences, further comprising the step of:
graphically displaying said device information through said particular device according to device graphical output preferences.

33. The method for monitoring devices utilized within a messaging session according to claim 30, said step of outputting said device information through said particular device according to device output preferences further comprising the step of:
audibly outputting said device information through said particular device according to device audible output preferences.

34. A system for monitoring devices utilized within a messaging session, said system comprising:
a client messaging system communicatively connected to a network;
said client messaging system further comprising:
means for receiving device information for at least one other device utilized by at least one other user participating in a messaging session at a particular device utilized by a particular user participating in said messaging session; and
means for outputting said device information through said particular device according to device output preferences, such that said particular device is enabled to monitor said device information for said at least one other device utilized in said messaging session.

35. The system for monitoring devices utilized within a messaging session according to claim 34, said means for receiving device information for at least one other device, further comprising:
means for receiving said device information comprising at least one from among a power level, a signal strength, a cost for participating, a device type, and a location.

36. The system for monitoring devices utilized within a messaging session according to claim 34, said means for outputting said device information through said particular device according to device output preferences, further comprising:
means for graphically displaying said device information through said particular device according to device graphical output preferences.

37. The system for monitoring devices utilized within a messaging session according to claim 34, said means for outputting said device information through said particular device according to device output preferences further comprising:
means for audibly outputting said device information through said particular device according to device audible output preferences.

38. A program, for monitoring devices utilized within a messaging session, residing on a computer usable medium having computer readable program code means, said program comprising:
means for receiving device information for at least one other device utilized by at least one other user participating in a messaging session at a particular device utilized by a particular user participating in said messaging session; and
means for outputting said device information through said particular device according to device output preferences, such that said particular device is enabled to monitor said device information for said at least one other device utilized in said messaging session.

39. The program for monitoring devices utilized within a messaging session according to claim 38, said program further comprising:
means for receiving said device information comprising at least one from among a power level, a signal strength, a cost for participating, a device type, and a location.

40. The program for monitoring devices utilized within a messaging session according to claim 38, said program further comprising:
means for graphically displaying said device information through said particular device according to device graphical output preferences.

41. The program for monitoring devices utilized within a messaging session according to claim 38, said program further comprising:
means for audibly outputting said device information through said particular device according to device audible output preferences.
